(19) United States
(12) Patent Application Publication
(10) Pub. No.: US 2021/0161739 A1
(43) Pub. Date: Jun. 3, 2021

(54) STEERING MECHANISM AND WHEELCHAIR EQUIPPED WITH SAME

(71) Applicant: HONDA MOTOR CO., LTD., MINATO-KU, TOKYO (JP)

(72) Inventors: Junji TAKADO, SAITAMA (JP); Hiroshi GOMI, SAITAMA (JP); Yasushi YONEDA, KANAGAWA (JP)

(21) Appl. No.: 17/045,057

(22) PCT Filed: Dec. 28, 2018
(86) PCT No.: PCT/JP2018/048576

§ 371 Date: Oct. 2, 2020

(30) Foreign Application Priority Data
Jun. 27, 2018 (JP) 2018-121582

(51) Int. Cl. A61G 5/02; A61G 5/10

(52) U.S. Cl. CPC A61G 5/026; A61G 5/1051

(57) ABSTRACT

Provided is a steering mechanism (8) including a swing bar (81a) which swings in response to input from a rider, a cam guide (83c) slidable on a peripheral surface of a column section (5a), a ball joint (82a) which slides the cam guide (83c) in response to the swinging of the swing bar (81a), a cam follower (83b) vertically provided on the peripheral surface of the column section (5a) to rotate the column section (5a) in response to the sliding of the cam guide (83c), and a coil spring (83e) which returns the cam guide (83c) to a predetermined rotation angle. The cam follower (83b) comes in contact with a cam surface (83c4) of the cam guide (83c) which has a recess surface shape, at two positions on the peripheral surface, in a state where the column section (5a) is located at a predetermined position.

### TECHNICAL FIELD

The present invention relates to a steering mechanism for use in a wheelchair, particularly a racing wheelchair for use in a track race, a marathon or the like, and a wheelchair equipped with the steering mechanism.

### BACKGROUND ART

Heretofore, there has been a racing wheelchair for use in a track race, a marathon or the like, comprising a cage where a rider sits down, a pair of rear wheels attached to right and left sides of the cage, a vehicle body frame extended in front of the cage, a front fork rotatably attached to the vehicle body frame, and a front wheel (a steering wheel) held by the front fork.

In this type of wheelchair, as a mechanism which rotates the front fork to set a steering angle of the front wheel, a mechanism comprising not only a handle coupled to the front fork but also a steering mechanism called a track lever is known (e.g., see Patent Literature 1).

The steering mechanism of Patent Literature 1 comprises a swing bar which swings right and left relative to the vehicle body frame, a link mechanism to transmit the swinging of the swing bar to the front wheel, and a maintenance mechanism to maintain the steering angle of the front wheel.

According to this steering mechanism, the rider presses the track lever provided at a rear end of the swing bar so as to lightly tap the lever from either the left or right. Consequently, the steering angle of the front wheel can be changed via the swing bar and the link mechanism, and the steering angle can be maintained at a predetermined angle by the maintenance mechanism. Therefore, in general, this steering mechanism is for use, for example, in running around a corner in a track race or the like.

### CITATION LIST

### Patent Literature

Patent Literature 1: Japanese Patent Laid-Open No. 2012-000394

### SUMMARY OF INVENTION

### Technical Problem

In the steering mechanism described in Patent Literature 1, a swing bar is built in a vehicle body frame. However, a part of a link mechanism (specifically, including a damper link, a coupling arm which couples the damper link and the swing bar, and a vice handle which couples the damper link and a front fork) is disposed in a state of protruding to a side of the vehicle body frame.

Consequently, there is concern that the part which is not housed in the vehicle body frame of the steering mechanism generates air resistance. Furthermore, there is concern that the part is conspicuous and spoils aesthetics.

The present invention has been developed in view of respects described above, and an object thereof is to provide a steering mechanism of a structure which is easy to house in a vehicle body frame, and a wheelchair equipped with the mechanism.

### Solution to Problem

A steering mechanism of the present invention is a steering mechanism of a wheelchair comprising a cage where a rider sits down, a vehicle body frame extended in front of the cage, a holding member rotatably attached to the vehicle body frame, and a steering wheel held by the holding member, the holding member having a rod-like pole section rotatably supported by the vehicle body frame to rotate integrally with the steering wheel, the steering mechanism comprising:

a swing bar which swings in response to input from the rider,

a sliding section having an abutment surface and being slidable at least in a peripheral direction on a peripheral surface of the pole section,

a first link section which couples the swing bar and the sliding section to slide the sliding section in response to the swinging of the swing bar,

a second link section which is vertically provided on the peripheral surface of the pole section to protrude from the peripheral surface, and which abuts on the abutment surface to rotate the pole section in response to the sliding of the sliding section, and

an urging section which urges the sliding section to rotate and return the pole section to a predetermined rotation angle via the sliding section and the second link section,

wherein the abutment surface is a recess surface dented in a direction along a rotation axis of the pole section,

the second link section is located at a bottom of the abutment surface in a state where the pole section is at the predetermined rotation angle, and

the second link section comes in contact with the abutment surface at two positions on the peripheral surface of the second link section, when the second link section is located at the bottom of the abutment surface.

In the steering mechanism of the present invention including such a configuration, to set the steering angle of the steering wheel via the steering mechanism, first, force input by the rider is transmitted to the sliding section via the swing bar and the first link section. Afterward, the sliding section rotates, via the second link section, the pole section in which the second link section is provided, to set the rotation angle of the pole section (i.e., the steering angle of the steering wheel).

Here, the second link section is provided on the peripheral surface of the pole section. Furthermore, the sliding section is configured to slide on the peripheral surface of the pole section. That is, in this steering mechanism, a part of the mechanism to set the steering angle of the steering wheel is located in a vicinity of the peripheral surface of the pole section, or configured to operate in the vicinity of the peripheral surface.

Consequently, in this steering mechanism, the part of the mechanism to set the steering angle of the steering wheel is easy to house in a part of the vehicle body frame which is also used in a conventional wheelchair (specifically, for example, a cover section provided at a front end of the vehicle body frame to cover the pole section, or the like).

Therefore, in the steering mechanism of the present invention, as compared with a conventional steering mechanism, the part of the mechanism can be easily housed in the vehicle body frame. Therefore, when the mechanism is mounted in the wheelchair, aerodynamic performance degradation and aesthetic deterioration due to the steering mechanism can be suppressed.

Additionally, in general, a steering mechanism for a racing wheelchair comprises an urging section which returns the steering angle of the steering wheel (i.e., the rotation angle of the pole section of the holding member which holds the steering wheel) to a predetermined angle.

However, in a case where an urging force of the urging section is too strong and when the rider performs an operation to set the steering angle, a large frictional force is generated between members which form the steering mechanism. There is concern that due to the frictional force, resistance is generated, and rattling is generated. Such resistance and rattling are especially easily generated, when the operation is started (i.e., when the pole section is rotated from a predetermined angle).

To solve the problem, in this steering mechanism, the abutment surface of the sliding section is formed in the recess surface shape. Furthermore, in a state where the urging section brings the pole section at the predetermined rotation angle, the second link section is located at the bottom of the abutment surface, and the second link section comes in contact with the abutment surface at two positions on the peripheral surface of the second link section.

Consequently, in this steering mechanism, a part where the sliding section comes in contact with the second link section is reduced, and the frictional force generated between the sections is decreased to suppress the resistance and rattling which are generated when the rider performs the operation to set the steering angle.

Furthermore, in the steering mechanism of the present invention,

it is preferable that the second link section is a column vertically provided on the peripheral surface of the pole section.

According to this configuration, the frictional force between the second link section and a sliding surface can be further decreased.

Furthermore, in the steering mechanism of the present invention,

it is preferable that the sliding section is disposed at a position shifted with respect to the second link section in the direction along the rotation axis of the pole section, and

the abutment surface is formed in an end surface of the sliding section on a side of the second link section.

According to this configuration, a mechanism which transmits force from the sliding section to the pole section is a simple structure, and hence the mechanism can be decreased in size. Consequently, a part of the steering mechanism can be further easily housed in the vehicle body frame, and hence the aerodynamic performance degradation and aesthetic deterioration due to the steering mechanism can be further easily suppressed.

Additionally, it is preferable that the steering mechanism of the present invention comprises a first regulating section extended from the sliding section in the direction along the rotation axis of the pole section, and a second regulating section disposed at a position which faces the first regulating section in the direction along the rotation axis,

the first regulating section faces the second regulating section via a predetermined space in a state where the pole section is at the predetermined rotation angle, and

the abutment surface of the sliding section is formed in a shape to move the first regulating section together with the sliding section to a side of the second regulating section, when the pole section is rotated via the second link section.

According to this configuration, when the pole section is rotated to a range more than or equal to a predetermined rotation range, the first regulating section abuts on the second regulating section, to regulate the rotation. This can prevent the pole section from being excessively rotated (i.e., the steering angle of the steering wheel from being excessively increased).

Additionally, in a case where the steering mechanism of the present invention comprises the first regulating section and the second regulating section,

it is preferable that the sliding section includes a regulating protrusion which abuts on the second link section to regulate the rotation of the pole section, when the pole section rotates in a state where the first regulating section and the second regulating section abut on the abutment surface.

According to such configuration, the excessive rotation of the pole section is inhibited not only by the first regulating section and the second regulating section but also by the regulating protrusion. Here, since the regulating protrusion is provided on the abutment surface of the sliding section, force applied to the regulating protrusion can be received also by the first link section and the steering wheel which are coupled to the sliding section, via the sliding section on which the abutment surface is formed.

Consequently, even in a case where a large force is applied to the pole section in excess of the predetermined rotation range (e.g., in a state where the first regulating section already abuts on the second regulating section), the rotation can be sufficiently inhibited.

Furthermore, a wheelchair of the present invention comprises a cage where a rider sits down, a vehicle body frame extended in front of the cage, a holding member rotatably attached to the vehicle body frame, and a steering wheel held by the holding member, the holding member including a rod-like pole section rotatably supported by the vehicle body frame to rotate integrally with the steering wheel, characterized by comprising any one of the above steering mechanisms.

Additionally, in the wheelchair of the present invention,

it is preferable that the vehicle body frame comprises a cover section which covers at least a part of the pole section, and

at least the sliding section and the second link section are housed in the cover section.

Also, in a conventional wheelchair, the cover section which covers at least a part of the pole section is used. Furthermore, in the above steering mechanism, at least the sliding section and the second link section are provided in a surrounding part of the pole section. Consequently, the sliding section and the second link section can be easily housed in the heretofore used cover section. Therefore, according to the wheelchair of the present invention, the steering mechanism of a new design can be incorporated in the wheelchair without changing the conventional design significantly.

Furthermore, in the wheelchair of the present invention,

it is preferable that the swing bar is attached at a front end, swingably about a swing axis, to an inside part of the vehicle body frame, and

the vehicle body frame is a hollow member inside which the swing bar is swingable.

Among members which form the steering mechanism of the wheelchair of the present invention, the swing bar is a member having a comparatively large size. Therefore, if the swing bar is configured to be housed in the vehicle body frame, the aerodynamic performance degradation and aesthetic deterioration can be efficiently suppressed.

Furthermore, the swing axis of the swing bar is provided at the front end, so that the vehicle body frame which houses the swing bar can be formed in a tapered shape. Consequently, the shape of the vehicle body frame is easily formed in a shape which is advantageous in aerodynamic performance.

### BRIEF DESCRIPTION OF DRAWINGS

FIG. 1 is a side view of a wheelchair according to an embodiment of the present invention.

FIG. 2 is a plan view of the wheelchair of FIG. 1.

FIG. 3 is a perspective view of a front fork of the wheelchair of FIG. 1 seen from a front surface side.

FIG. 4 is an exploded perspective view of a surrounding part of a steering mechanism of the wheelchair of FIG. 1.

FIG. 5 is a perspective view of the steering mechanism of FIG. 4.

FIG. 6A is a plan view showing a configuration of the steering mechanism of FIG. 4.

FIG. 6B is a side view showing the configuration of the steering mechanism of FIG. 4.

FIG. 7A is a plan view of the steering mechanism of FIG. 4, and shows a state where a column section is not rotated.

FIG. 7B is a plan view of the steering mechanism of FIG. 4, and is a view showing a state where the column section is rotated via the steering mechanism.

FIG. 8 is an exploded perspective view showing a structure of a surrounding part of the column section of the steering mechanism of FIG. 4.

FIG. 9A is a front view showing a configuration of the surrounding part of the column section of the steering mechanism of FIG. 4, and is a view showing a state where the column section is not rotated.

FIG. 9B is a front view showing the configuration of the surrounding part of the column section of the steering mechanism of FIG. 4, and is a view showing a state where the column section is operated and rotated via a handle.

FIG. 10A is a cross-sectional view showing a configuration of a surrounding part of the column section of the steering mechanism of FIG. 4 on a fork section side and is a view showing a state where the column section is not rotated.

FIG. 10B is a cross-sectional view showing the configuration of the surrounding part of the column section of the steering mechanism of FIG. 4 on the fork section side, and is a view showing a state where the column section is rotated.

### DESCRIPTION OF EMBODIMENTS

Hereinafter, description will be made as to a configuration of a wheelchair W according to an embodiment with reference to the drawings. The wheelchair W is for use in a track race, a marathon or the like.

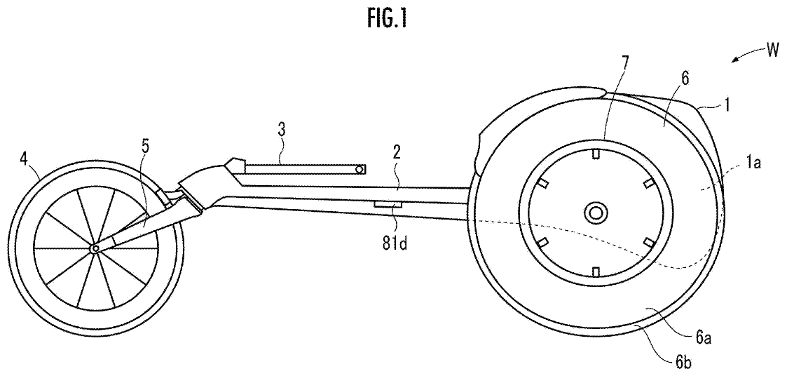

First, a schematic configuration of the wheelchair W will be described with reference to FIG. 1 to FIG. 3.

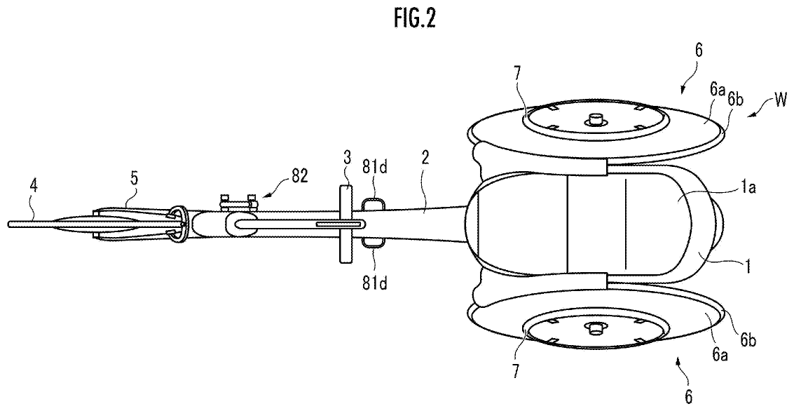

As shown in FIG. 1 and FIG. 2, the wheelchair W comprises a cage 1, a vehicle body frame 2 extended in front of the cage 1, a steering handle 3 provided in the vehicle body frame 2, a front wheel 4 (a steering wheel) disposed at a front end of the vehicle body frame 2, a front fork 5 (a holding member) attached to the front end of the vehicle body frame 2, and coupled to the handle 3, to hold the front wheel 4, a pair of rear wheels 6 attached to right and left sides of the cage 1, and a hand rim 7 attached to a side of the rear wheels 6 opposite to the cage 1.

As shown in FIG. 2, the cage 1 has an upper part opened, and in the cage, a sitting seat 1a, on which an athlete (a rider) sits down, is disposed.

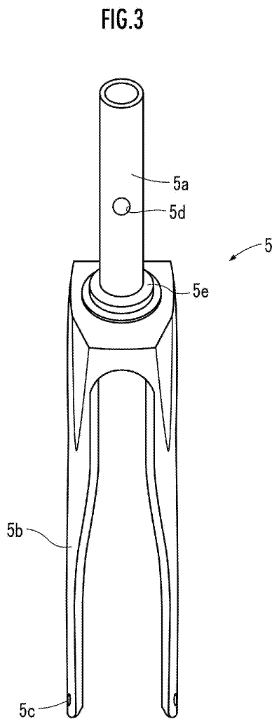

The handle 3 is coupled to a rear end of an after-mentioned column section 5a (see FIG. 3) of the front fork 5 pivotally supported by the front end of the vehicle body frame 2.

Each rear wheel 6 is composed of a wheel 6a, and a tire 6b fitted in the wheel 6a. The rear wheel 6 is attached to the cage 1 in a state where the wheel is inclined so that an upper part is closer to a center side of a cage 1 side.

The hand rim 7 is fixed rotatably integrally with the rear wheel 6. The athlete who sits down on the sitting seat 1a transmits a driving force to the rear wheel 6 via the hand rim 7.

As shown in FIG. 3, the front fork 5 includes the column section 5a (a pole section) supported by the front end of the vehicle body frame 2, and a fork section 5b extending forward from the column section 5a in a bifurcated state.

A bearing hole 5c which supports an axle of the front wheel 4 is formed at a front end of the fork section 5b. Furthermore, a first fixing hole 5d to fix a cam follower 83b of an after-mentioned steering mechanism 8 is formed in an almost center of the column section 5a. An annular first bearing 5e is fitted in an end of the column section 5a on a fork section 5b side.

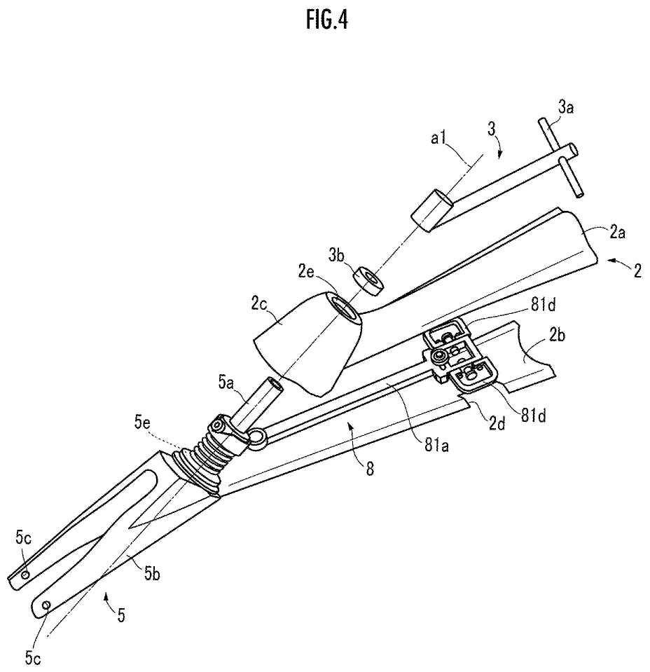

The column section 5a is a hollow rod-like (i.e., tubular) member. This member is to acquire strength of the column section 5a, and may be a solid rod-like member. The column section 5a is rotatably supported at the front end of the vehicle body frame 2 via the annular first bearing 5e, at an end on the fork section 5b side (a front side). The handle 3 is coupled to the end of the column section 5a on a side opposite to the fork section 5b (a rear side) (see FIG. 4).

In the wheelchair W comprising such front fork 5, upon rotation of the handle 3, the column section 5a coupled to the handle 3, the fork section 5b connected to the column section 5a and the front wheel 4 held by the fork section 5b responsively rotate integrally.

Consequently, in the wheelchair W, the handle 3 is operated to set an orientation of the front wheel 4 (a steering angle of the front wheel 4) via the front fork 5, so that the wheelchair W can turn and run in a desired direction.

Note that a shape of the holding member of the present invention is not limited to such a shape of the front fork 5 as described above, as long as the holding member can hold the steering wheel and includes the pole section rotatably supported by the vehicle body frame. For example, in place of such a fork section as described above, an arm section which is not bifurcated may be employed.

Additionally, in the wheelchair W of the present embodiment, not only the handle 3 but also the steering mechanism 8 are employed as the mechanism to set the steering angle of the front wheel 4. Therefore, next, description will be made in detail as to a structure of the handle 3 and the steering mechanism 8 of the wheelchair W and a surrounding part with reference to FIG. 4 to FIG. 10.

As shown in FIG. 4, the vehicle body frame 2 includes an upper surface frame 2a and a lower surface frame 2b extended forward from the cage 1 (see FIG. 1 and FIG. 2), and a front end frame 2c (a cover section) provided at a front end of a tubular portion.

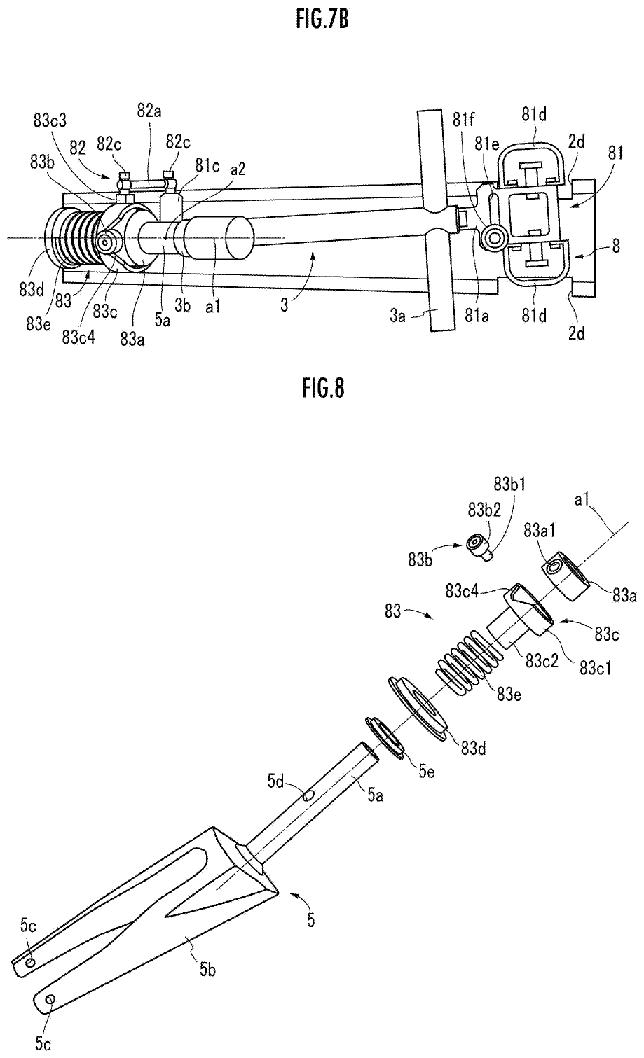

The upper surface frame 2a and the lower surface frame 2b are connected to each other to form a tubular member. An upper surface side of the tubular member is formed by the upper surface frame 2a, and a lower surface side thereof is formed by the lower surface frame 2b. In an internal space of the tubular member, an after-mentioned swing bar 81a of the steering mechanism 8 is housed swingably right and left about a front end (see FIG. 7).

Furthermore, a pair of first insertion holes 2d are formed in opposite side surfaces of the lower surface frame 2b. The pair of first insertion holes 2d are formed at corresponding positions of a pair of track levers 81d provided on opposite side surfaces of a rear end of the after-mentioned swing bar 81a, respectively. The first insertion holes 2d are sized to such an extent that, when the swing bar 81a swings, the track levers 81d can be inserted in and removed from the holes.

The front end frame 2c is formed by a cup-shaped member with an opening facing downward. A second insertion hole 2e is formed at a rear end of the front end frame 2c (a bottom of a cup). The front end frame 2c is disposed above the fork section 5b of the front fork 5, and the column section 5a is inserted into the front end frame.

In a state where the front end frame 2c is attached to the front fork 5, a part of the steering mechanism 8 is housed in an internal space of the front end frame 2c, and a portion of a rear end of the column section 5a protrudes from the second insertion hole 2e of the front end frame 2c.

The handle 3 includes a handle main body 3a held to be operated by the rider, and a second bearing 3b which rotatably supports the handle main body 3a to the front end frame 2c.

The handle main body 3a is a T-shaped member in plan view. A rear end of the handle main body has a shape which can be held by the rider. On a lower surface side of a front end of the body, a second fixing hole (not shown) is formed. The rear end of the column section 5a protruding from the front end frame 2c of the vehicle body frame 2 is inserted and fixed to the second fixing hole.

The second bearing 3b is an annular member disposed between the handle main body 3a and the front end frame 2c, and a portion of the column section 5a which protrudes from the front end frame 2c is inserted into the bearing. The second bearing 3b rotatably supports the handle main body 3a to an upper surface of a peripheral edge of the second insertion hole 2e of the front end frame 2c.

In the handle 3 including such a configuration, the handle main body 3a is rotatable integrally with the column section 5a and the front wheel 4 and about a center axis of the column section 5a of the front fork (i.e., a rotation axis a1 of the column section 5a).

That is, in the wheelchair W, a rotation angle of the column section is changed not only by operating the after-mentioned steering mechanism 8 but also by rotating the handle main body 3a, so that the steering angle of the front wheel 4 can be set.

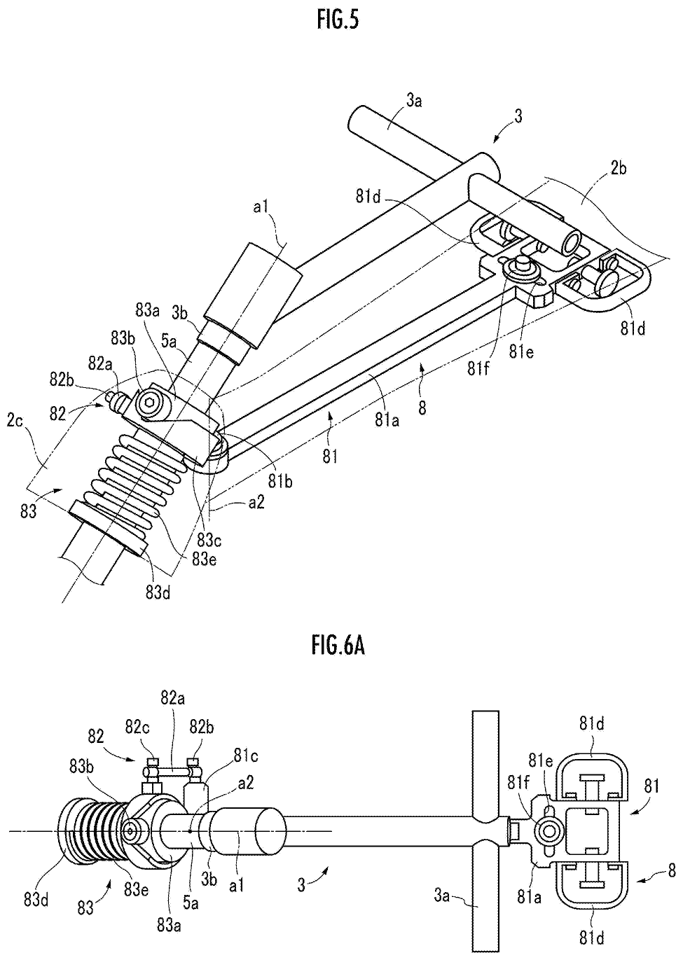

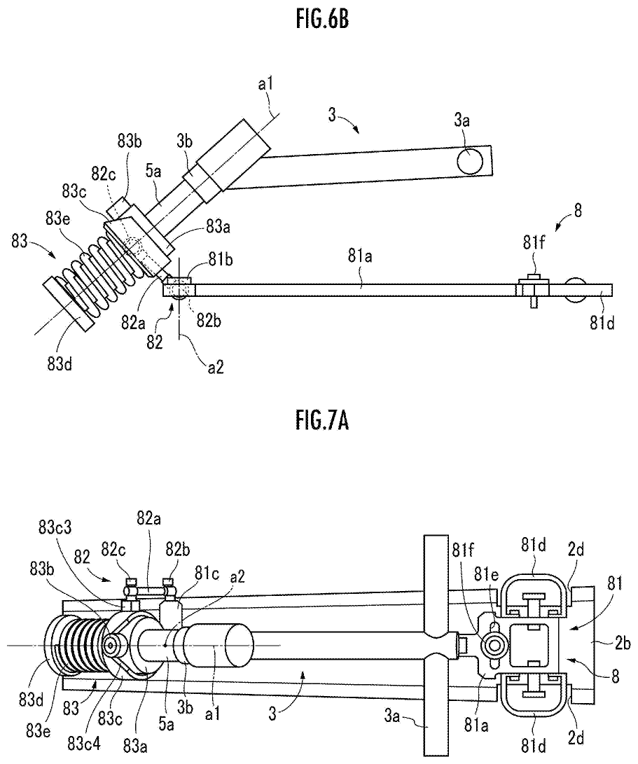

As shown in a perspective view of FIG. 5 seen from a front side and a plan view of FIG. 6A as well as a side view of FIG. 6B, the steering mechanism 8 comprises an input section 81 into which force to change the steering angle is input by the rider, a transmitting section 82 to transmit the force input into the input section 81, and a rotating section 83 which changes the steering angle of the front wheel 4 with the force transmitted from the transmitting section 82, to change the rotation angle of the column section 5a.

The input section 81 includes the swing bar 81a extending in a front-rear direction, a first pin 81b which fixes a front end of the swing bar 81a to the vehicle body frame 2 swingably in a right-left direction, a first coupling protrusion 81c vertically provided on a peripheral surface of the front end of the swing bar 81a, a pair of track levers 81d fixed to both right and left surfaces of a rear end of the swing bar 81a, a slide hole 81e formed at the rear end of the swing bar 81a, and a second pin 81f inserted into the slide hole 81e and fixed to the vehicle body frame 2.

The rider pushes or taps the track levers 81d to swing the swing bar 81a, and inputs, into the steering mechanism 8, the force to set the steering angle of the front wheel 4. The force is transmitted to the transmitting section 82 via the first coupling protrusion 81c vertically provided on the front end of the swing bar 81a.

As shown in FIG. 7, the swing bar 81a is swung freely, by the first pin 81b, about a swing axis a2 (see FIG. 6B) which coincides with an axis of the first pin 81b.

As shown in FIG. 7A, in a state where any force to set the steering angle of the front wheel 4 is not input from the rider and the swing bar 81a is not swung, the pair of track levers 81d slightly protrude from the first insertion holes 2d formed in the opposite side surfaces of the vehicle body frame 2, respectively (see FIG. 2).

On the other hand, as shown in FIG. 7B, in a state where the force to set the steering angle of the front wheel 4 is input from the rider and the swing bar 81a is swung, one of the pair of track levers 81d protrudes from the first insertion hole 2d formed on one side of the vehicle body frame 2, and the other track lever is housed in the vehicle body frame 2.

The slide hole 81e is an oblong hole extending through the rear end of the swing bar 81a in an up-down direction, and is formed to be slightly wider than a diameter of a shaft portion of the second pin 81f. A peripheral edge of the slide hole 81e is pressed by a first head portion of the second pin 81f inserted into the slide hole 81e.

Therefore, the peripheral edge of the slide hole 81e is held between the first head portion and the vehicle body frame 2 to which the second pin 81f is fixed. Consequently, a swing position of the swing bar 81a is maintained with a pressing force from the second pin 81f and the vehicle body frame 2 to the swing bar 81a.

That is, in a case where the steering angle of the front wheel 4 is set via the swing bar 81a, the steering angle can be fixed to a predetermined angle. Specifically, for example, in a case where the wheelchair W is for use in a track race, the steering angle can be fixed to an angle of a corner of a track.

Furthermore, in either a state where the column section 5a is not rotated or a state where the column section 5a is rotated, the swing bar 81a is housed in the vehicle body frame 2 (specifically, the tubular member formed by the upper surface frame 2a and the lower surface frame 2b).

Here, the swing bar 81a swings right and left about the axis of the first pin 81b provided at the front end (the swing axis a2). Consequently, in the wheelchair W, a tapered member may be employed as the tubular member of the vehicle body frame 2 which houses the swing bar 81a. Therefore, the vehicle body frame 2 has an advantageous shape in aerodynamic performance.

Note that a swing direction of the swing bar in the present invention is not limited to the right-left direction, and may be appropriately designed in accordance with a configuration of the wheelchair. The direction may be, for example, an up-down direction or a front-rear direction.

Furthermore, in the present invention, a mechanism which inputs the force to set the steering angle of the steering wheel into the swing bar is not limited to such a mechanism of the track levers 81d as described above. For example, in a case of a configuration where the swing bar swings right and left, a link mechanism which is driven by sliding a protrusion may be provided in a vicinity of the rear end of the swing bar, and such force may be input into the swing bar via the link mechanism.

Additionally, the vehicle body frame of the present invention is not limited to such a tapered shape as described above, and may be appropriately designed in accordance with the aerodynamic performance and design properties of the whole wheelchair, and additionally the structure and a shape of the steering mechanism.

The transmitting section 82 includes a rod-like ball joint 82a (a first link member), a third pin 82b to rotatably fix a rear end of the ball joint 82a to the first coupling protrusion 81c vertically provided at the front end of the swing bar 81a, and a fourth pin 82c to rotatably fix a front end of the ball joint 82a to a second coupling protrusion 83c3 of an after-mentioned cam guide 83c of the rotating section 83.

The force to set the steering angle of the front wheel 4 that is input by pressing the track lever 81d of the input section 81 by the rider is transmitted to the transmitting section 82 via the swing bar 81a and the first coupling protrusion 81c of the input section 81. Afterward, the force is transmitted to the cam guide 83c of the rotating section 83 via the transmitting section 82.

As shown in FIG. 8, the rotating section 83 comprises a tubular cam spacer 83a, a cam follower 83b (a second link section) fixed to the first fixing hole 5d of the column section 5a via the cam spacer 83a, the tubular cam guide 83c disposed below the cam spacer 83a in a direction along the rotation axis a1 of the column section 5a, an annular adapter 83d (a second regulating section) which is disposed below the cam guide 83c in the direction along the rotation axis a1, and into which the column section 5a is inserted, and a coil spring 83e (an urging section) disposed between the cam guide 83c and the adapter 83d.

The cam spacer 83a is a tubular member into which the column section 5a of the front fork 5 is inserted. The cam spacer 83a is formed with a third insertion hole 83a1 formed to extend through the cam spacer 83a in a radial direction.

The cam follower 83b includes a shaft portion 83b1 vertically provided on a peripheral surface of the column section 5a of the front fork 5, and a second head portion 83b2 attached to the shaft portion 83b1 on a side opposite to the column section 5a. A shape of the second head portion 83b2 is a columnar shape having the same axis as in the shaft portion 83b1. The second head portion 83b2 is rotatable about the axis of the shaft portion 83b1 to the shaft portion 83b1.

Note that the second link section of the present invention is not limited to such a shape, as long as the second link section is vertically provided to protrude toward a peripheral surface of the pole section. For example, as the cam follower, a simply columnar member which does not include any rotating portion may be employed. Furthermore, as the second link section, not a columnar member but also a pillar-like member having a polygonal cross-sectional shape may be used. Alternatively, a protrusion which gently protrudes from the peripheral surface of the pole section may be used as the second link section.

The shaft portion 83b1 of the cam follower 83b is inserted into the third insertion hole 83a1 of the cam spacer 83a. In a state of being inserted into the third insertion hole 83a1, a tip of the shaft portion 83b1 is inserted in and fixed to the first fixing hole 5d of the column section 5a of the front fork 5.

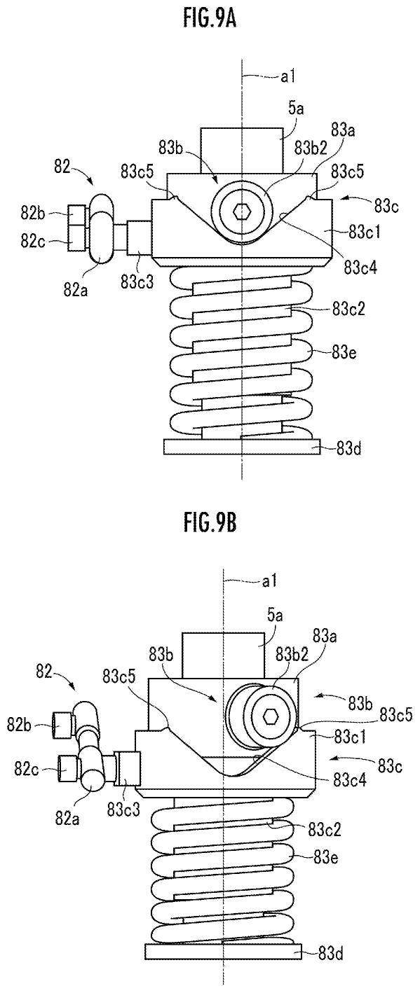

Consequently, when the column section 5a is rotated, an inner peripheral surface of the third insertion hole 83a1 is pressed by the shaft portion 83b1, and the cam spacer 83a, the cam follower 83b and the column section 5a rotate integrally about the rotation axis a1 (see FIG. 9).

The cam guide 83c is a tubular member into which the column section 5a of the front fork 5 is inserted, and which can house a lower portion of the cam spacer 83a. The cam guide 83c is slidable in the direction along the rotation axis a1 of the column section 5a and a peripheral direction of the column section 5a on the peripheral surface (an outer peripheral surface) of the column section 5a.

The cam guide 83c includes a tubular large diameter section 83c1 (a sliding section) located below the cam follower 83b in the direction along the rotation axis a1 of the column section 5a of the front fork 5, a tubular small diameter section 83c2 (a first regulating section) extended downward from the large diameter section 83c1 in the direction along the rotation axis a1, and a second coupling protrusion 83c3 (not shown in FIG. 8, see FIG. 9) vertically provided on a peripheral surface of the large diameter section 83c1.

An inner diameter of the large diameter section 83c1 is slightly larger than an outer diameter of the cam spacer 83a. Consequently, the large diameter section 83c1 is slidable in the peripheral direction and the direction along the rotation axis a1 on the peripheral surface of the column section 5a (strictly, on a peripheral surface of the cam spacer 83a fitted in the column section 5a).

The large diameter section 83c1 includes, on an end surface on a cam follower 83b side, a cam surface 83c4 (an abutment surface) having a recess surface shape dented in the direction along the rotation axis a1. The cam surface 83c4 abuts on a peripheral surface of the second head portion 83b2 of the cam follower 83b. Furthermore, the large diameter section 83c1 includes a pair of regulating protrusions 83c5 which protrude slightly upward from opposite ends of the cam surface 83c4 in the direction along the rotation axis a1 (not shown in FIG. 8, see FIG. 9).

Note that a position where the abutment surface of the present invention is formed is not limited to the end surface of the sliding section, as long as the abutment surface can abut on the second link section. For example, a through hole extending through an inner peripheral surface and an outer peripheral surface of the sliding section may be formed, and the inner peripheral surface of the through hole may serve as the abutment surface.

An inner diameter of the small diameter section 83c2 is slightly larger than an outer diameter of the column section 5a, and is smaller than the outer diameter of the cam spacer 83a. Consequently, the small diameter section 83c2 is slidable in the peripheral direction on the peripheral surface of the column section 5a, in a region below the cam spacer 83a along the rotation axis a1. Furthermore, an outer diameter of the small diameter section 83c2 is smaller than an outer diameter of the large diameter section 83c1, and is sized to such an extent that the coil spring 83e can be fitted around the small diameter section.

Furthermore, a length of the small diameter section 83c2 in the direction along the rotation axis a1 is shorter than a distance between a lower end of the cam spacer 83a and an upper end of the adapter 83d. Therefore, the small diameter section 83c2 is slidable in the direction along the rotation axis a1 on the peripheral surface of the column section 5a between the ends.

As shown in FIG. 9, the ball joint 82a of the transmitting section 82 is rotatably fixed to the second coupling protrusion 83c3 with the fourth pin 82c. Consequently, when force to swing the swing bar 81a is input into the swing bar 81a of the input section 81, the force is transmitted to the cam guide 83c via the second coupling protrusion 83c3 to which the ball joint 82a is coupled, to slide the cam guide 83c in the peripheral direction on the peripheral surface of the column section 5a (see FIG. 7).

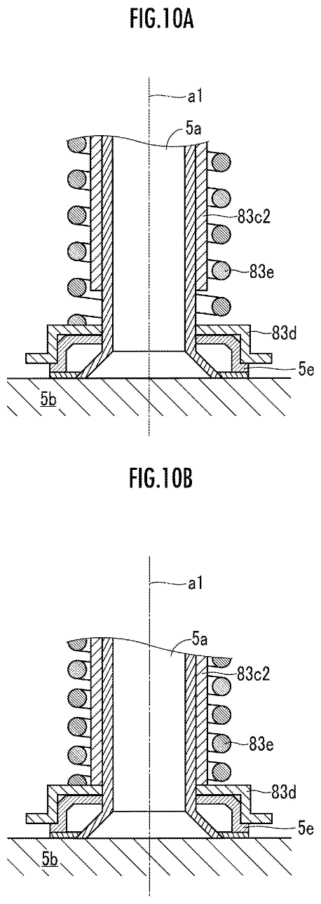

Turning back to FIG. 8, the adapter 83d is an annular member into which the column section 5a of the front fork 5 is inserted. Furthermore, the adapter 83d is a cover-like member including a dent on a lower surface side (see FIG. 10), and covers the first bearing 5e located below the adapter 83d so as to house the bearing in the dent.

Furthermore, the adapter 83d faces a lower end of the small diameter section 83c2 of the cam guide 83c in the direction along the rotation axis a1 of the column section 5a of the front fork 5. An outer diameter of the adapter 83d is sized to such an extent that the adapter is fitted in an opening formed on a lower side of the front end frame 2c of the vehicle body frame 2.

The column section 5a and the small diameter section 83c2 of the cam guide 83c are inserted into the coil spring 83e. An upper end of the coil spring 83e abuts on a lower surface of the large diameter section 83c1 of the cam guide 83c. On the other hand, a lower end of the coil spring 83e abuts on the adapter 83d.

Here, movement of the adapter 83d in the direction along the rotation axis a1 of the column section 5a of the front fork 5 is regulated by an upper end surface of the fork section 5b of the front fork 5 (see FIG. 10). Consequently, the coil spring 83e urges the cam guide 83c toward upside (i.e., the cam follower 83b side) in the direction along the rotation axis a1.

Next, description will be made as to operations of the handle 3, the front fork 5, and the steering mechanism 8 in the wheelchair W in a case of setting the steering angle of the front wheel 4, with reference to FIG. 5 to FIG. 7, FIG. 9 and FIG. 10.

First, description will be made as to an operation in a case of operating the handle 3 to set the steering angle of the front wheel 4.

As shown in FIG. 5, the handle 3 is fixed to the rear end of the column section 5a of the front fork 5. Consequently, when the rider holds the handle 3 to rotate the handle 3 about the rotation axis a1 of the column section 5a, the column section 5a rotates together with the handle 3, and the steering angle of the front wheel 4 held by the fork section 5b of the front fork 5 is set.

At this time, as shown in FIG. 9, the cam follower 83b fixed to the column section 5a presses the cam surface 83c4 of the cam guide 83c while moving in the peripheral direction of the column section 5a (e.g., while moving from a position shown in FIG. 9A to a position shown in FIG. 9B).

Here, the cam surface 83c4 has the recess surface shape dented downward in the direction along the rotation axis a1, and hence the cam guide 83c not only slides in the peripheral direction but also slides downward in the direction along the rotation axis a1.

Therefore, a part of force to slide the cam guide 83c is transmitted to the swing bar 81a as force in a direction to slide the swing bar 81a, via the ball joint 82a connected to the cam guide 83c (see FIG. 6). However, the force is received by the second pin 81f and the vehicle body frame 2 between which the swing bar 81a is held, and hence the swing bar 81a does not swing.

Additionally, a rotation range of the handle 3 is regulated by the small diameter section 83c2 and the regulating protrusions 83c5 of the cam guide 83c, as well as the adapter 83d.

Specifically, as shown in FIG. 10, the small diameter section 83c2 and the adapter 83d are arranged opposite to each other on the rotation axis a1. Then, when the column section 5a is rotated via the handle 3, the cam follower 83b fixed to the column section 5a moves the cam guide 83c including the small diameter section 83c2 downward (i.e., from a position of FIG. 10A to a position of FIG. 10B) in the direction along the rotation axis a1.

Consequently, if the rider is to rotate the column section 5a via the handle 3 in a range more than or equal to a predetermined rotation range, the lower end of the small diameter section 83c2 abuts on an upper surface of the adapter 83d.

As a result, the rotation of the column section 5a to which the cam follower 83b is fixed and the handle 3 coupled to the column section 5a is regulated via the cam surface 83c4 of the cam guide 83c including the small diameter section 83c2 and the cam follower 83b which abuts on the cam surface 83c4.

Turning back to FIG. 9, if the handle 3 is to be further rotated in a state where the small diameter section 83c2 abuts on the adapter 83d (a state of FIG. 9B), there is concern that the cam follower 83b falls out of a range where the cam follower can abut on the cam surface 83c4.

However, the opposite ends of the cam surface 83c4 are provided with the pair of regulating protrusions 83c5 over which the cam follower 83b cannot ride. Therefore, excessive rotation of the handle 3 to such an extent the cam follower 83b falls out is regulated by the regulating protrusions 83c5.

Additionally, since the regulating protrusions 83c5 are provided on the cam surface 83c4 of the cam guide 83c, force applied to the regulating protrusions 83c5 is also received by the ball joint 82a and the swing bar 81a coupled to the cam guide 83c, via the cam guide 83c formed with the cam surface 83c4. Consequently, even if a very large force is applied to the handle 3, the force is sufficiently received.

A height of each of the regulating protrusions 83c5 may be appropriately set in accordance with the rotation range to be regulated, or the like. For example, in a case where the cam follower 83b rotates about an axis of the shaft portion 83b1 (see FIG. 8) as in the present embodiment, the regulating protrusion may be provided at a position which is higher than a position of the axis.

After the column section 5a is rotated via the handle 3, the rider releases the handle 3, to reach a state where force to maintain a rotating state of the handle 3 is not input. In this state, the handle 3 automatically returns to a predetermined rotation angle determined in advance.

Specifically, the cam guide 83c is urged toward the upside (i.e., the cam follower 83b side) in the direction along the rotation axis a1, by the coil spring 83e. Consequently, in the state where any force is not input via the handle 3, an urging force of the coil spring 83e causes the cam guide 83c to press the cam follower 83b via the cam surface 83c4.

Thus, the cam follower 83b, the column section 5a to which the cam follower 83b is fixed and the handle 3 coupled to the column section 5a are pressed by the cam guide 83c, to automatically return to the predetermined rotation angle determined in advance. Furthermore, at this time, the cam guide 83c also slides to return to a predetermined position, due to a reaction force received by the cam follower 83b via the cam surface 83c4.

Note that the sliding section of the present invention is not limited to the sliding section including the first regulating section and the second regulating section, such as the small diameter section 83c2 and the adapter 83d of the present embodiment, as well as the regulating protrusion 83c5. For example, in a case where a mechanism which inhibits the excessive rotation of the handle is separately provided, the first regulating section and the second regulating section as well as the regulating protrusion may be omitted, and the first regulating section and the second regulating section may only be provided.

Furthermore, the steering mechanism of the present invention is not limited to a steering mechanism including an urging section such as the coil spring 83e of the present embodiment. For example, in place of the coil spring, an elastic body such as a rubber may form a mechanism that automatically returns the rotation angle of the pole section. Alternatively, to decrease a weight, the mechanism that returns the rotation angle itself may be omitted.

Next, description will be made as to an operation in a case of operating the steering mechanism 8 to set the steering angle of the front wheel 4.

As shown in FIG. 7, in the case of setting the steering angle of the front wheel 4 via the steering mechanism 8, the rider presses or taps the track levers 81d, to input force for the setting.

Thus, upon the input of the force for the setting, the swing bar 81a swings in the right-left direction about the axis (the swing axis a2) of the first pin 81b located at the front end of the swing bar 81a (see FIG. 5 and FIG. 6B) against a pressing force of the second pin 81f and the vehicle body frame 2 between which the swing bar 81a is held.

When the swing bar 81a swings in this way, the force for the setting is transmitted to the second coupling protrusion 83c3 of the cam guide 83c (and consequently the whole cam guide 83c) via the first coupling protrusion 81c of the swing bar 81a and the ball joint 82a which is attached to the first coupling protrusion 81c.

The cam guide 83c slides in the peripheral direction on the peripheral surface of the column section 5a of the front fork 5 due to the force transmitted from the ball joint 82a. At this time, a pressing force in the peripheral direction on the peripheral surface of the column section 5a is applied from the cam surface 83c4 formed on the large diameter section 83c1 of the cam guide 83c to the cam follower 83b.

Consequently, the column section 5a to which the cam follower 83b is fixed rotates together with the cam follower 83b about the rotation axis a1 (turns from a state of FIG. 7A to a state of FIG. 7B). As a result, the steering angle of the front wheel 4 held by the fork section 5b of the front fork 5 is set. Note that at this time, the handle 3 rotates integrally with the column section 5a in response to the rotation of the column section 5a (rotates from a position of FIG. 7A to a position of FIG. 7B).

At this time, the reaction force is applied from the cam follower 83b to the cam surface 83c4 of the cam guide 83c. The cam surface 83c4 has the recess surface shape dented in the direction along the rotation axis a1, and hence the cam guide 83c slides toward downside (a left side in FIG. 7A) in the direction along the rotation axis a1 against the urging force of the coil spring 83e.

In other words, force to return to a non-rotating state (a state of being located in a predetermined rotated position) is applied to the cam guide 83c via the cam surface 83c4 due to the urging force of the coil spring 83e, in the peripheral direction and the direction along the rotation axis a1. In the present embodiment, force to return to a state of being located at the position of FIG. 7A is applied.

Here, the swing bar 81a is held between the second pin 81f and the vehicle body frame 2. Therefore, the swing position of the swing bar 81a is maintained with the pressing force between the swing bar 81a and the second pin 81f and vehicle body frame 2, as long as the rider does not directly operate the track levers 81d.

Therefore, in a case where the steering angle of the front wheel 4 is set via the steering mechanism 8, the swing position of the swing bar 81a is maintained, and the rotated position of the cam guide 83c coupled to the swing bar 81a via the ball joint 82a (and consequently the setting of the steering angle of the front wheel 4) is also maintained against the urging force of the coil spring 83e.

Consequently, in the case where the steering angle of the front wheel 4 is set via the steering mechanism 8, the steering angle can be fixed to the predetermined angle. Specifically, for example, in the case where the wheelchair W is for use in a track race, the steering angle can be fixed to the angle of the corner of the track.

As described above, in the steering mechanism 8, in the case of setting the steering angle of the front wheel 4 via the steering mechanism 8, first, the force input by the rider is transmitted to the large diameter section 83c1 of the cam guide 83c (and consequently the whole cam guide 83c) via the swing bar 81a and the ball joint 82a.

Afterward, the cam guide 83c causes the cam follower 83b to rotate the column section 5a to which the cam follower 83b is fixed, to set the rotation angle of the column section 5a (i.e., the steering angle of the front wheel 4).

Here, the cam follower 83b is fixed to the peripheral surface of the column section 5a. Furthermore, the cam guide 83c including the large diameter section 83c1 is configured to slide on the peripheral surface of the column section 5a. That is, in the steering mechanism 8, a part of the mechanism to set the steering angle of the front wheel 4 is located in a vicinity of the peripheral surface of the column section 5a, or configured to operate in the vicinity of the peripheral surface.

Consequently, in this steering mechanism 8, a part of the mechanism to set the steering angle of the steering wheel 4 is easy to house in a part of the vehicle body frame 2 which is also used in a conventional wheelchair (specifically, the front end frame 2c provided at the front end of the vehicle body frame 2 to cover a portion of the column section 5a on the fork section 5b side).

Therefore, in the steering mechanism 8 of the present embodiment, as compared with the conventional steering mechanism, a part of the mechanism can be easily housed in the vehicle body frame 2. Consequently, when the mechanism is mounted in the wheelchair W, aerodynamic performance degradation and aesthetic deterioration due to the steering mechanism 8 can be suppressed.

Additionally, in the steering mechanism 8, the force to return to the non-rotating state (the state of being located at the predetermined rotated position) is applied to the cam guide 83c via the cam surface 83c4 due to the urging force of the coil spring 83e, in the peripheral direction and the direction along the rotation axis a1.

The force causes the cam surface 83c4 of the cam guide 83c to press the cam follower 83b, and the rotation angle of the cam follower 83b and the column section 5a to which the cam follower 83b is fixed reaches the predetermined rotation angle.

At this time, a frictional force corresponding to the urging force of the coil spring 83e is generated in an abutment portion between the cam surface 83c4 and the cam follower 83b. Therefore, depending on a size of the urging force of the coil spring 83e, there is concern that smooth movement is hindered by resistance, rattling or the like caused by the frictional force, in a case where the cam guide 83c is moved so that a position of the cam guide 83c changes from the predetermined rotated position to another position.

To solve the problem, as shown in FIG. 9A, in the steering mechanism 8, the cam surface 83c4 is formed in the recess surface shape dented downward in the direction along the rotation axis a1 of the column section 5a of the front fork 5, and is configured so that the cam follower 83b is located at the bottom of the cam surface 83c4 in a state where the column section 5a is at the predetermined rotation angle.

Furthermore, the steering mechanism 8 is configured so that the cam follower 83b comes in linear contact with the cam surface 83c4 at two positions on the peripheral surface of the second head portion 83b2 of the cam follower 83b, when the cam follower 83b is located at the bottom of the cam surface 83c4. Specifically, the bottom of the cam surface 83c4 is formed in an arc shape having a curvature radius larger than a radius of the second head portion 83b2 of the cam follower 83b.

Consequently, in the steering mechanism 8, the force can be sufficiently transmitted, while inhibiting an excessive frictional force from being generated in the abutment portion between the cam surface 83c4 and the cam follower 83b.

Note that a shape of the abutment surface in the steering mechanism of the present invention is not limited to such a shape as described above. For example, in place of linear contact, point contact may be made. Alternatively, the point contact may be made at one of two contact positions, and the linear contact may be made at the other position.

Furthermore, for example, in a case where the frictional force between the second link section and the abutment surface is small enough to ignore, the abutment surface may have such a shape that the second link section comes in surface contact with the abutment surface in a state where the second link section is located at the bottom of the abutment surface having the recess surface shape. In such a configuration, the rotation angle in the state where the second link section is located at the bottom of the abutment surface can be stably held.

As above, the shown embodiment has been described, but the present invention is not limited to such an aspect.

For example, in the above embodiment, the cam surface 83c4, which is the abutment surface, may be formed in a shape to rotate the column section 5a, which is the pole section, via the second head portion 83b2, which is the second link section, in response to the sliding, when the ball joint 82a, which is the first link section, slides the cam guide 83c, which is the sliding section. This simplifies the mechanism which transmits the force from the sliding section to the pole section, to decrease the mechanism in size.

However, the second link section and the sliding section of the present invention are not limited to such a configuration, as long as the sliding section is slidable on the peripheral surface of the pole section and the second link section is provided on the peripheral surface of the pole section and rotates the pole section in response to the sliding of the sliding section.

For example, a cam groove provided in the peripheral surface of the pole section may be formed as the second link section, and a pin slidably fitted in the cam groove may be formed as the sliding section.

Furthermore, in the above embodiment, the ball joint 82a is employed as the first link member. However, the first link member of the present invention is not limited to the structure of the ball joint, as long as an after-mentioned sliding section is slid on the peripheral surface of the pole section in response to the swinging of the swing bar.

For example, unlike the large diameter section 83c1 of the cam guide 83c of the present embodiment, the sliding section does not slide in the peripheral direction and the direction along the rotation axis on the peripheral surface of the pole section, and the sliding section slides only in the direction along the rotation axis a1. In this case, the first link member may slide the sliding section in the direction along the rotation axis of the pole section in response to the swinging of the swing bar.

Additionally, for example, in the above embodiment, a part of the steering mechanism 8 is housed in the front end frame 2c which is the cover section. However, the steering mechanism of the present invention is not limited to such a configuration. For example, a part of the steering mechanism may be housed in another cover section formed separately from the heretofore used cover section. Alternatively, the whole steering mechanism may be housed in the cover section.

### REFERENCE SIGNS LIST

1 cage
1a sitting seat
2 vehicle body frame
2a upper surface frame
2b lower surface frame
2c front end frame (a cover section)
2d first insertion hole
2e second insertion hole
3 handle
3a handle main body
3b second bearing
4 front wheel (a steering wheel)
5 front fork (a holding member)
5a column section (a pole section)
5b fork section
5c bearing hole
5d first fixing hole
5e first bearing
6 rear wheel
6a wheel
6b tire
7 hand rim
8 steering mechanism
81 input section
81a swing bar
81b first pin
81c first coupling protrusion
81d track lever
81e slide hole
81f second pin
82 transmitting section
82a ball joint (a first link section)
82b third pin
82c fourth pin
83 rotating section
83a cam spacer
83a1 third insertion hole
83b cam follower (a second link section)
83b1 shaft portion
83b2 second head portion
83c cam guide
83c1 large diameter section (a sliding section)
83c2 small diameter section (a first regulating section)
83c3 second coupling protrusion
83c4 cam surface (an abutment surface)
83c5 regulating protrusion
83d adapter (a second regulating section)
83e coil spring (an urging section)
W wheelchair
a1 rotation axis
a2 swing axis

1. A steering mechanism of a wheelchair comprising a cage where a rider sits, a vehicle body frame extended in front of the cage, a holding member rotatably attached to the vehicle body frame, and a steering wheel held by the holding member, the holding member having a rod-like pole section rotatably supported by the vehicle body frame to rotate integrally with the steering wheel, the steering mechanism comprising:
a swing bar which swings according to input from the rider,
a sliding section having an abutment surface and being slidable at least in a peripheral direction on a peripheral surface of the pole section,
a first link section which couples the swing bar and the sliding section to slide the sliding section according to the swinging of the swing bar,
a second link section which is vertically provided on the peripheral surface of the pole section to protrude from the peripheral surface, and which abuts on the abutment surface to rotate the pole section according to the sliding of the sliding section, and
an urging section which urges the sliding section to rotate and return the pole section to a predetermined rotation angle via the sliding section and the second link section,
wherein the abutment surface is a recess surface dented in a direction along a rotation axis of the pole section,
the second link section is located at a bottom of the abutment surface in a state where the pole section is at the predetermined rotation angle, and
the second link section comes in contact with the abutment surface at two positions on the peripheral surface of the second link section, when the second link section is located at the bottom of the abutment surface.

2. The steering mechanism according to claim 1, wherein the second link section is a column vertically provided on the peripheral surface of the pole section.

3. The steering mechanism according to claim 1, wherein the sliding section is disposed at a position shifted with respect to the second link section in the direction along the rotation axis of the pole section, and
the abutment surface is formed in an end surface of the sliding section on the second link section side.

4. The steering mechanism according to claim 1, further comprising:
a first regulating section extended from the sliding section in the direction along the rotation axis of the pole section, and
a second regulating section disposed at a position which faces the first regulating section in the direction along the rotation axis,
wherein the first regulating section faces the second regulating section via a predetermined space in a state where the pole section is at the predetermined rotation angle, and
the abutment surface of the sliding section is formed in a shape to move the first regulating section together with the sliding section to the second regulating section side, when the pole section is rotated via the second link section.

5. The steering mechanism according to claim 4, wherein the sliding section includes a regulating protrusion which abuts on the second link section to regulate the rotation of the pole section, when the pole section rotates in a state where the first regulating section and the second regulating section abut on the abutment surface.

6. A wheelchair comprising:
a cage where a rider sits,
a vehicle body frame extended in front of the cage,
a holding member rotatably attached to the vehicle body frame, and
a steering wheel held by the holding member, the holding member including a rod-like pole section rotatably supported by the vehicle body frame to rotate integrally with the steering wheel,
wherein the wheelchair comprises the steering mechanism according to claim 1.

7. The wheelchair according to claim 6, wherein the vehicle body frame comprises a cover section which covers at least a part of the pole section, and
at least the sliding section and the second link section are housed in the cover section.

8. The wheelchair according to claim 6, wherein the swing bar is attached at a front end, swingably about a swing axis, to an inside part of the vehicle body frame, and
the vehicle body frame is a hollow member inside which the swing bar is swingable.
